(19) United States
(12) Patent Application Publication
(10) Pub. No.: US 2008/0087634 A1
(43) Pub. Date: Apr. 17, 2008

(54) MANUFACTURING METHOD OF SEMICONDUCTOR DEVICE

(75) Inventors: Toshiyuki Kohsaka, Yamanashi (JP); Tsutomu Komatani, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EUDYNA DEVICES, Yamanashi (JP)

(21) Appl. No.: 11/872,224

(22) Filed: Oct. 15, 2007

(30) Foreign Application Priority Data
Oct. 13, 2006 (JP) 2006-279351

(51) Int. Cl. B44C 1/22

(52) U.S. Cl. 216/41

(57) ABSTRACT

A manufacturing method of a semiconductor device includes forming a metal mask on a substrate or on a layer provided on the substrate, and removing at least one of the substrate and the layer provided on the substrate selectively through a dry etching treatment with use of the metal mask. The metal mask has a first open pattern and a second open pattern. The first open pattern is opened at a given area of the metal pattern. The second open pattern is opened at an area dividing the metal mask.

### BACKGROUND OF THE INVENTION

1. Field of the Invention

This invention generally relates to a manufacturing method of a semiconductor device, and in particular, relates to a manufacturing method of a semiconductor device in which a substrate is subjected to an etching treatment with a metal mask.

2. Description of the Related Art

A substrate (or a layer on the substrate) is subjected to an etching treatment with use of a mask layer as a mask, when the substrate is subjected to a selective dry etching treatment. An etching rate is reduced when a reaction constant of the substrate with respect to plasma is small. In particular, there is a demand for enlarging an etching selectivity so that the mask layer is disappeared in the etching process when a thick substrate is subjected to an etching treatment, the etching selectivity being a ratio of an etching rate of the substrate to that of the mask. A metal mask is used as a mask having a large etching selectivity. Japanese Patent Application Publication No. 2-152230 discloses an art where a GaAs substrate is subjected to an etching treatment with use of a metal mask including Ni (nickel) as a mask.

A description will be given of a case where a SiC (silicon carbide) substrate is subjected to an etching treatment with use of a metal mask composed of Ni and a through hole is formed, as an example of a problem in a process of etching a substrate with use of a metal mask. FIG. 1 illustrates a top view of a wafer 11 on which a metal mask of Ni is formed on a SiC substrate. A plurality of chips 45 are arranged on the wafer 11. An area between each of the chips 45 is referred to an area 34. The area 34 is a scribe line for cutting the wafer 11 into the chip 45. A first open pattern 30 (that is, a pattern where the metal pattern is removed) is formed in the metal mask. The first open pattern 30 is used for forming a through hole in the SiC substrate. An etching rate of the SiC substrate is very small. And so, an etching treatment is performed with use of an etching device obtaining high-density plasma such as an ICP (Inductively-Coupled Plasma) etching device or an ECR (Electron Cyclotron Resonance) etching device, when the through hole is formed in the SiC substrate. For example, a fluorine (ion) concentration and an electron concentration are not high because a plasma density is low, in a case where an etching device having a low plasma density such as RIE (Reactive Ion Etching) is used. It is thus difficult to obtain the number of activation species and activation energy. Therefore, the etching rate is reduced.

However, it takes long time to form the through hole because the substrate itself is resistant, in a case where the SiC substrate is subjected to an etching treatment with use of a high-density plasma device. It causes an increase of temperature in the etching device and the substrate. Therefore, the SiC substrate warps because of a thermal expansion coefficient differential between the SiC substrate and Ni. And the substrate may be broken and there may be generated a crack. For example, the substrate tends to warp because of an increase of temperature, when the thickness of the substrate is reduced to 50-150 μm in order to form a chip from the substrate. The metal mask has a large etching selectivity with respect to the substrate. However, the substrate tends to warp because the metal mask has a thermal expansion coefficient larger than that of the substrate.

### SUMMARY OF THE INVENTION

The present invention provides a manufacturing method of a semiconductor device in which a warpage, a breaking, a crack and so on caused by the thermal expansion coefficient differential between the substrate and the metal mask are restrained.

According to an aspect of the present invention, preferably, there is provided a manufacturing method of a semiconductor device including forming a metal mask on a substrate or on a layer provided on the substrate, and removing at least one of the substrate and the layer provided on the substrate selectively through a dry etching treatment with use of the metal mask. The metal mask has a first open pattern and a second open pattern. The first open pattern is opened at a given area of the metal pattern. The second open pattern is opened at an area dividing the metal mask.

With the above-mentioned method, it is possible to reduce a thermal stress caused by a thermal expansion coefficient differential between the substrate and the metal mask when a temperature of the substrate is increased during an etching treatment. It is therefore possible to restrain a warp of the substrate.

### BRIEF DESCRIPTION OF THE DRAWINGS

Preferred embodiments of the present invention will be described in detail with reference to the following drawings, wherein:

FIG. 1 illustrates a top view showing a conventional etching method;

FIG. 2 illustrates a top view showing an etching method in accordance with a first embodiment;

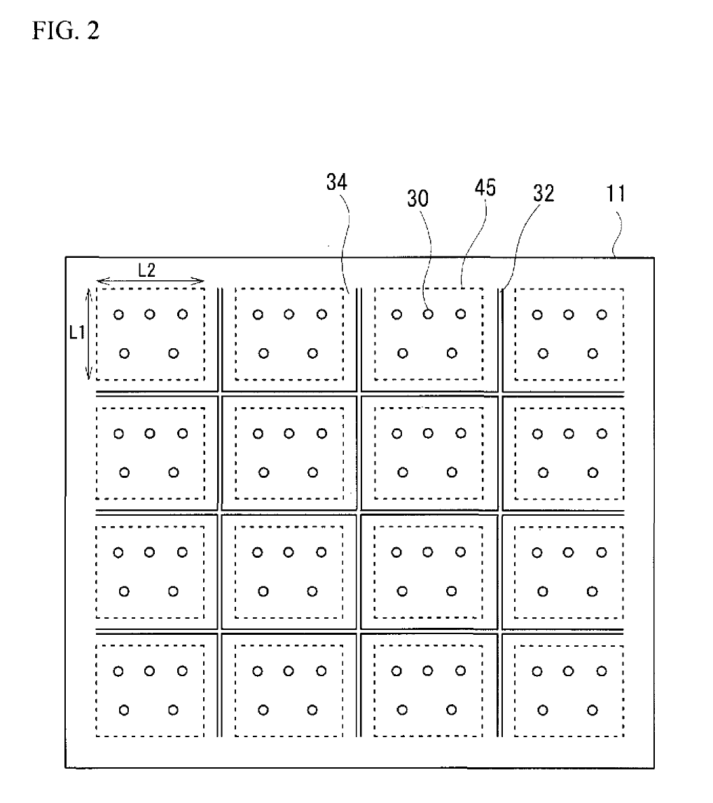

FIG. 3A through FIG. 3D illustrate a cross sectional view showing a manufacturing method of a semiconductor device in accordance with a first embodiment;

FIG. 4A through FIG. 4C illustrate a cross sectional view showing a manufacturing method of a semiconductor device in accordance with a first embodiment;

FIG. 5 illustrates a top view (part one) showing an etching method in accordance with another example of a first embodiment;

FIG. 6 illustrates a top view (part two) showing an etching method in accordance with another example of a first embodiment;

FIG. 7 illustrates a top view (part three) showing an etching method in accordance with another example of a first embodiment;

FIG. 8A and FIG. 8B illustrate a manufacturing method of a semiconductor device in accordance with a second embodiment; and

FIG. 9 illustrates a manufacturing method of a semiconductor device in accordance with a third embodiment.

### DESCRIPTION OF THE PREFERRED EMBODIMENTS

A description will now be given, with reference to the accompanying drawings, of embodiments of the present invention.

### FIRST EMBODIMENT

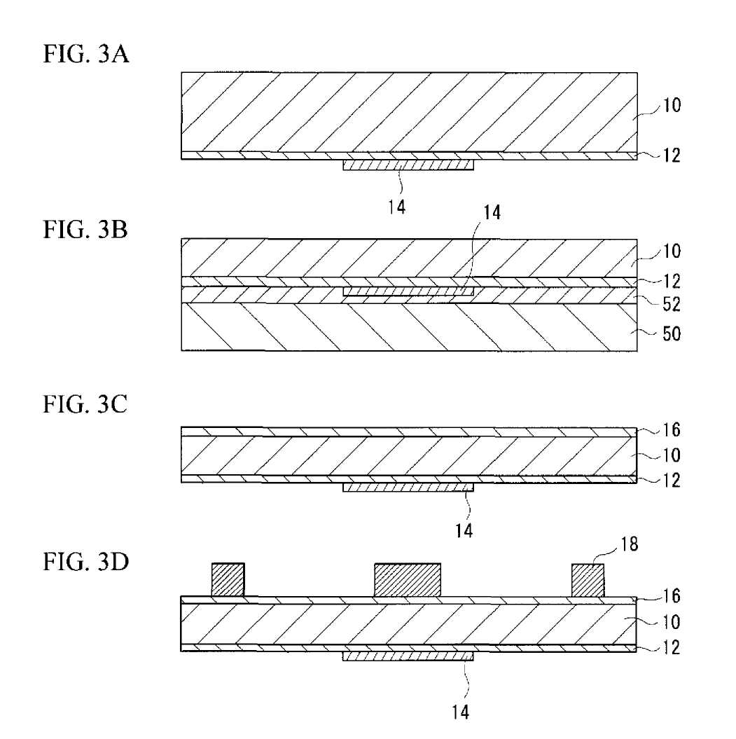

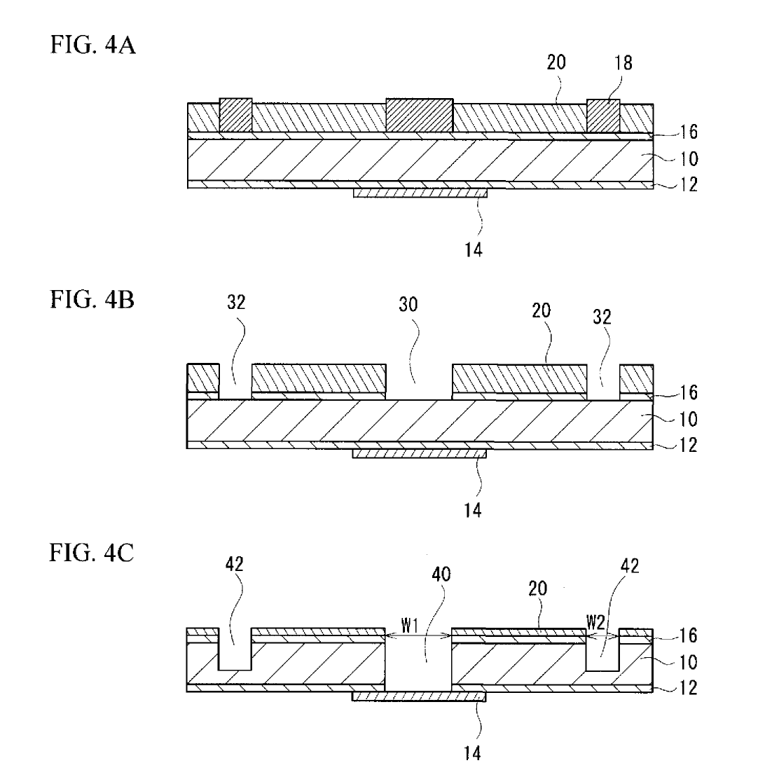

In a first embodiment, a metal mask composed of Ni or the like has a slit-shaped second open pattern 32 in the area 34 that is to be a scribe line, in addition to the first open pattern 30 for forming a through hole in a SiC substrate. FIG. 3A through FIG. 3D and FIG. 4A through FIG. 4C illustrate a cross sectional view showing a etching method of a SiC substrate in accordance with a first embodiment. The metal mask may be composed of Cu or the like having a large etching selectivity with respect to the substrate, in addition to Ni.

As shown in FIG. 3A, an epitaxial layer 12 composed of a GaN {gallium nitride}-based semiconductor layer or a SiC layer is formed on a front face (a face where an activation area or a circuit is formed) of a wafer-shaped SiC substrate 10. In FIG. 3A through FIG. 3D and FIG. 4A through FIG. 4C, the front face is illustrated down. An electrode pad 14 composed of Au is formed on a front face of the epitaxial layer 12. As shown in FIG. 3B, a front face of the SiC substrate 10 is adhered to a support substrate 50 such as a glass substrate with a wax 52. A back face (a face opposite to the front face) of the SiC substrate 10 is polished or grinded. In this process, the thickness of the SiC substrate 10 is reduced to 50-150 μm. The wafer-shaped SiC substrate 10 is adhered to the support substrate 50 in order to enhance a holding performance of the SiC substrate having a reduced thickness. The support substrate 50 and the wax 52 are not shown in FIG. 3C through FIG. 4C.

As shown in FIG. 3C, a seed metal layer 16 is formed on the back face of the SiC substrate 10. The seed metal layer 16 is composed of NiCr (nickel chrome)/Au (gold) or Ti (titanium)/Au (gold) or the like. As shown in FIG. 3D, a resist 18 is formed on the seed metal layer 16. The resist 18 remains at the first open pattern and the second open pattern.

As shown in FIG. 4A, Ni is coated on the seed metal layer 16, and a metal mask 20 is formed between each of the resists 18. As shown in FIG. 4B, the resist 18 is removed, and the seed metal layer 16 is subjected to an etching treatment with use of the metal mask 20 as a mask. And, the metal mask 20 having the first open pattern 30 and the second open pattern 32 is formed on the SiC substrate 10.

As shown in FIG. 4C, the SiC substrate 10 is subjected to an etching treatment with use of the metal mask as a mask. In this case, an ICP etching device is used. A description will be given of an etching condition. Etching gas is NF₃/O₂ or SF₀/O₂. A degree of vacuum is set to be 0.5 Pa to 2.0 Pa. The ICP power is set to be more than 2 kW. The RF power is set to be 150-500 W. The ECR power is set to be more than 1500 W when the ECR etching device is used. Other conditions are same as those in a case of the ICP etching device.

A width W1 of the first open pattern 30 is set to be approximately 100 μm. A width W2 of the second open pattern 32 is set to be approximately 20 μm. In this case, the SiC substrate 10 is etched to a depth of approximately 150 μm at the first open pattern 30. In this process, a through hole 40 is formed so as to pass through the SiC substrate 10. On the other hand, a recess 42 is etched to a depth of only approximately 30 μm and a through hole is not formed, because the width W2 is small and plasma is not provided in the recess 42 sufficiently. With the above-mentioned process, the through hole 40 and the recess 42 are formed in the SiC substrate 10. After that, the through hole 40 is filled with a metal, although this process is not shown. The support substrate 50 is detached. The SiC substrate 10 is cut along the area 34, and a chip 45 is formed. With the above-mentioned process, a chip having the through hole 40 is formed. The widths W1 and the W2 mentioned above are the smallest value at each of the patterns.

In the first embodiment, the metal mask 20 has the first open pattern 30 and the second open pattern 32 formed therein, the first open pattern being opened at a desirable area, the second open pattern being opened at an area dividing the metal mask 20 into a plurality of portions not coupled to each other. That is, the second open pattern 32 longer than lengths L1 and L2 to be a length of the chip 45 is formed in the metal mask 20 in addition to the first open pattern 30. As mentioned above, the metal mask 20 is divided into a plurality of portions (each of the portions is surrounded by the second open pattern 32) not coupled to each other. This results in a reduction of stress caused by a thermal expansion coefficient differential between the SiC substrate 10 and the metal mask 20 when a temperature of the substrate 10 increases during the etching treatment of the SiC substrate 10, in FIG. 4C. Therefore, it is possible to restrain the warp of the SiC substrate 10.

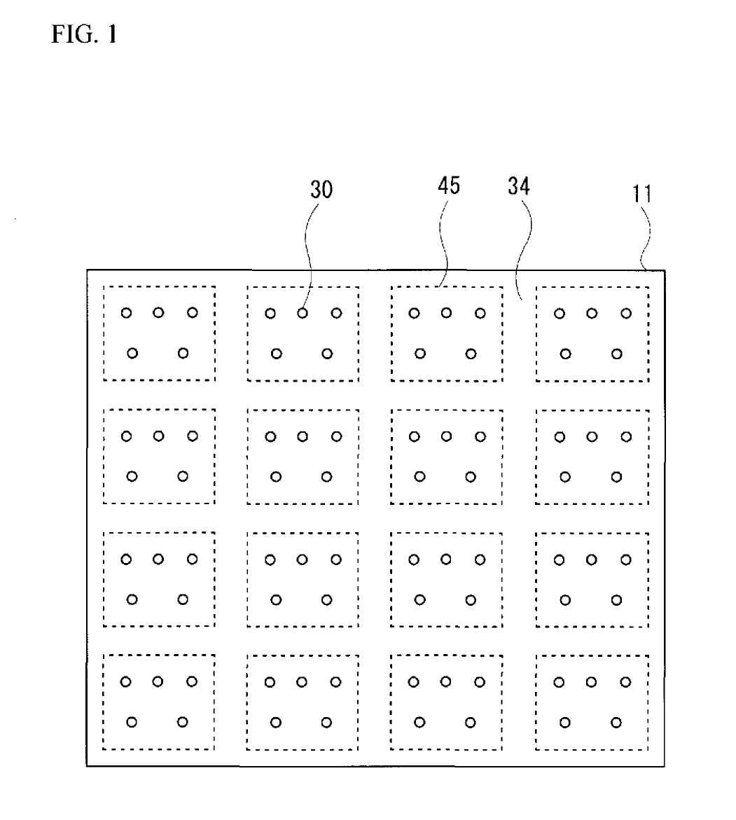

In the conventional embodiment shown in FIG. 1, an etching treatment at the through hole 40 and an etching treatment at the recess 42 are performed separately, when the SiC substrate 10 has the recess 42. A crack has been generated in the SiC substrate 10 because of the thermal expansion coefficient differential between the SiC substrate 10 and the metal mask 20, in an etching process at the first open pattern in the conventional embodiment shown in FIG. 1. And so, the present inventor finds a method of performing an etching treatment with the first open pattern 30 and an etching treatment with the second open pattern 32 in one process in order to solve this problem. In this case, an area ratio of the metal mask 20 with respect to the surface of the wafer 11 is reduced compared to the conventional embodiment. This results in a reduction of a stress to the SiC substrate 10 caused by the thermal expansion coefficient differential between the SiC substrate 10 and the metal mask 20. It is therefore possible to restrain a crack in the SiC substrate 10.

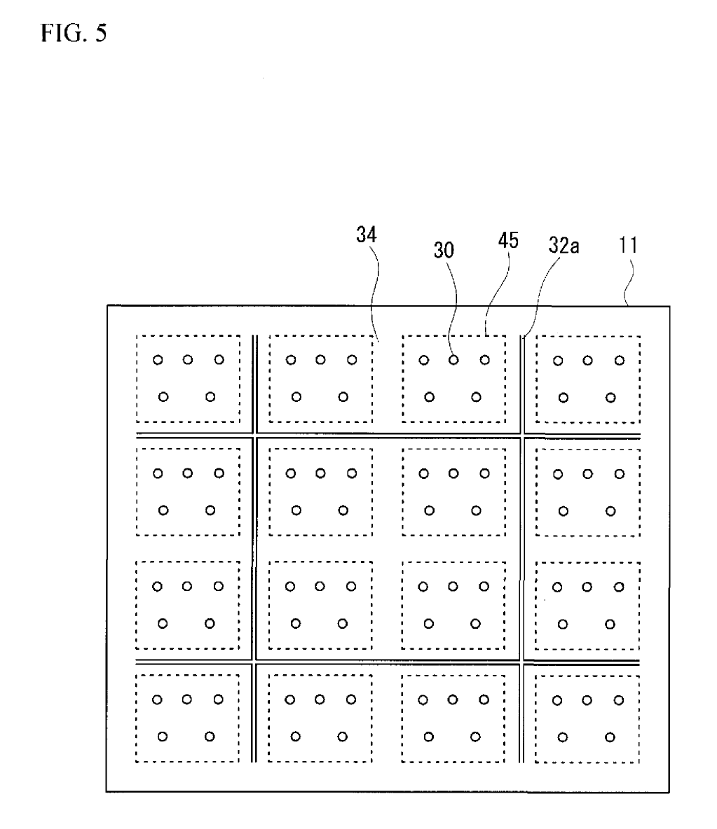

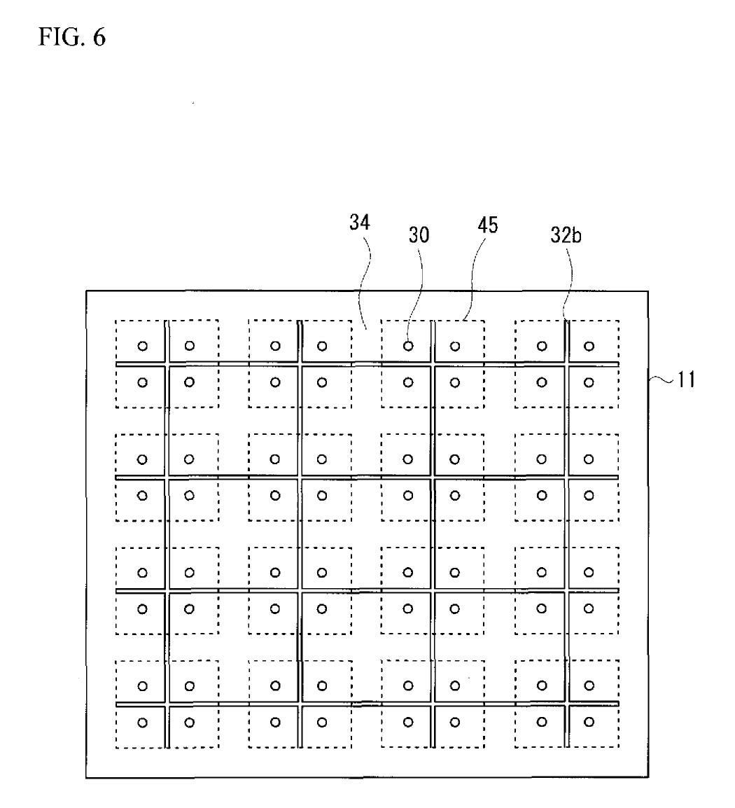

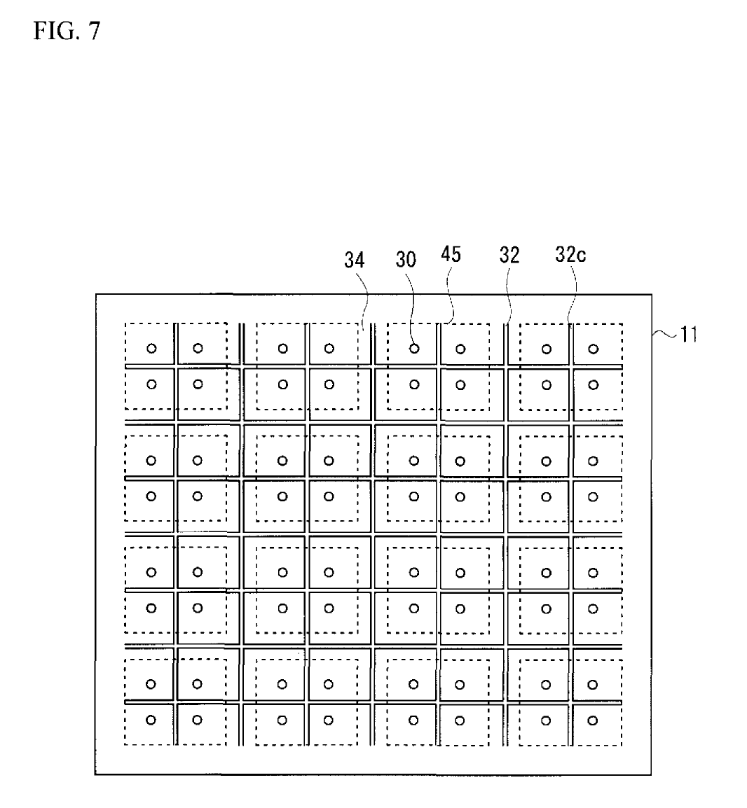

FIG. 5 through FIG. 7 illustrate another example of the first embodiment. As shown in FIG. 5, a second open pattern 32a may be formed so as to surround a plurality of chips at the area 34 that is to be the scribe line. As shown in FIG. 6, a second open pattern 32b may be formed so as to cross the chip 45. The second open pattern 32b may be formed at an area not having an effect on a device property. A recess formed with use of the second open pattern 32b may reduce a thermal stress applied to the substrate caused by a heat generated during the process of mounting the chips on a mount substrate. As shown in FIG. 7, the second open pattern 32 may be formed at the area 34 that is to be the scribe line, and a second open pattern 32c may be formed so as to cross the chip 45.

It is preferable that the second open pattern 32 may be formed at the area 34 that is to be the scribe line. In this case, it is possible to form the chip 45 by cutting the SiC substrate 10 with use of the recess 42. It is therefore possible to cut off the process of cutting the SiC substrate 10.

In the first embodiment and the other examples, the first open pattern 30 is a pattern for forming the through hole 40 passing through the SiC substrate 10. However, a recess not passing through the SiC substrate 10 may be formed with use of the first open pattern 30. However, a heat tends to be generated, because the etching treatment is performed in a long time when the through hole 40 is formed. Therefore, it is effective to form the second open pattern.

A metal layer used as the metal mask 20 is formed on the substrate 10 in the chip manufactured though the method shown in FIG. 6 and FIG. 7. The metal layer has the first open pattern 30 and the second open pattern 32 crossing the chip 45. The SiC substrate 10 has the through hole 40 regulated with the first open pattern 30 and has the recess 42 regulated with the second open pattern 32.

The second open pattern crossing the chip is formed on the metal layer in the chip manufactured in the method shown in FIG. 6 and FIG. 7. This results in a reduction of a stress even if a thermal stress is applied to the chip because of the thermal expansion coefficient differential between the metal layer and the SiC substrate in a temperature cycle. It is therefore possible to restrain the warp, the breaking and the crack caused by the temperature cycle.

The description is given of the case where the second open pattern 32 is a pattern for forming a recess crossing the area that is to be the chip in the above-mentioned embodiment. That is, the description is given of the case where the SiC substrate 10 is subjected to an etching treatment with use of the second open pattern 32 and the recess 42 not passing through the SiC substrate 10 is formed. However, a hole passing through the SiC substrate 10 may be formed with use of the second open pattern 32. However, the chips may be separated from each other when the SiC substrate 10 is detached from the support substrate, if the recess 42 passes through the SiC substrate 10. It is therefore preferable that the recess 42 does not pass through the SiC substrate 10, if the SiC substrate 10 is subjected to the etching treatment with use of the second open pattern 32.

In the first embodiment, the dry etching is performed, with the SiC substrate 10 being adhered to the support substrate 50. In this case, the temperature of the SiC substrate 10 tends to increase, because a heat generated in the SiC substrate 10 is released through the support substrate 50. It is therefore effective to form the second open pattern 32.

### SECOND EMBODIMENT

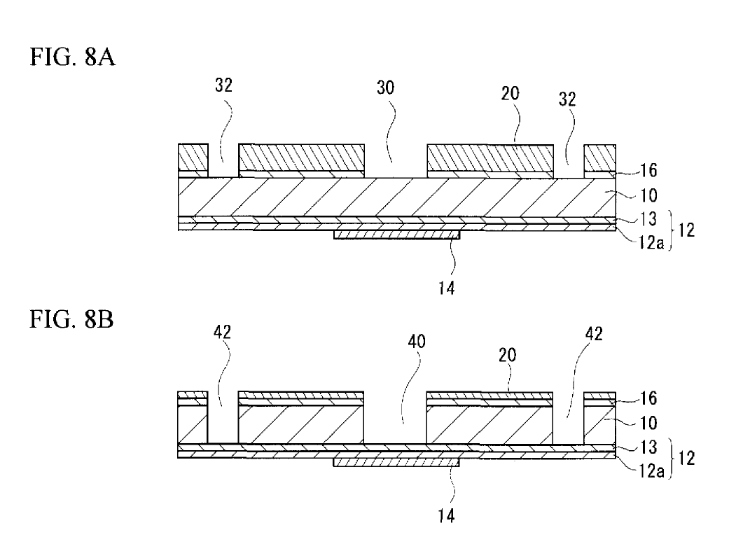

A second embodiment is a case where the epitaxial layer 12 has an etching stopper layer 13. As shown in FIG. 8A, the epitaxial layer 12 has the stopper layer 13 and a GaN-based semiconductor layer 12a. The stopper layer 13 is, for example, composed of AlGaN. As shown in FIG. 8B, the SiC substrate 10 is subjected to an etching treatment with use of the metal mask 20 as a mask. It is possible to enlarge an etching selectivity of AlGaN with respect to GaN and SiC by changing a ratio of AlN in AlGaN suitably. Therefore, the etching is stopped at the stopper layer 13. The chips may be separated from each other if the epitaxial layer 12 of the recess 42 is removed. In accordance with the second embodiment, it is possible to remain the epitaxial layer 12 at the recess 42. It is therefore possible to restrain the separation of the chips. The stopper layer 13 may be provided on at least an area where the second open pattern is formed, and may be formed on an area where the first open pattern is formed. And the stopper layer 13 may be provided on an optional area inside of the epitaxial layer 12 according to an object of providing the stopper layer 13.

### THIRD EMBODIMENT

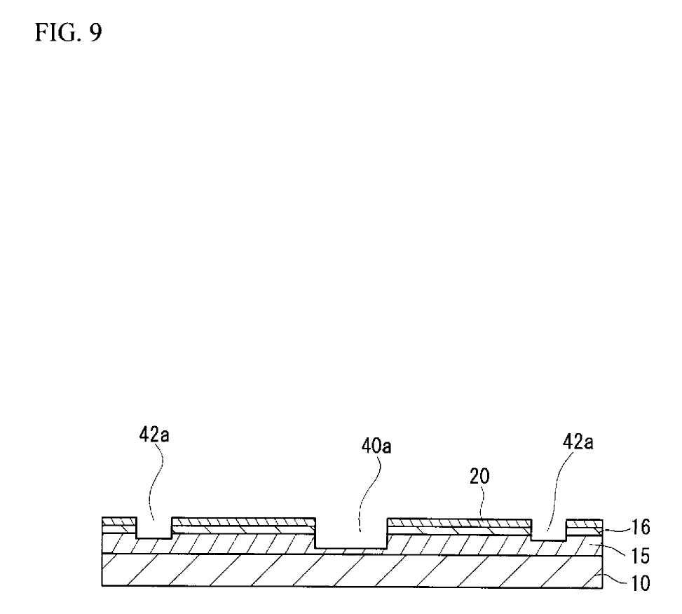

A third embodiment is a case where a GaN-based semiconductor layer 15 provided on a substrate is subjected to an etching treatment. As shown in FIG. 9, the GaN-based semiconductor layer 15 provided on the substrate 10 is subjected to a dry etching treatment with use of the metal mask 20 as a mask. And, patterns 40a and 42a are formed. A temperature of the substrate is increased because of a heat generated in an etching treatment if etching quantity is large, in a case where a layer provided on the substrate is subjected to the etching treatment. In accordance with the third embodiment, it is possible to restrain a generation of a crack caused by a thermal stress.

It may be at least one of the substrate 10 and a layer (the epitaxial layer 12 or the GaN-based semiconductor layer 15) provided on the substrate that are subjected to the dry etching treatment with use of the metal mask 20 as shown in the first through the third embodiments.

In the first through the third embodiments, the SiC substrate 10 is used. However, a substrate composed of Si, sapphire, silica and GaN may be used as the substrate. In particular, the SiC substrate, the sapphire substrate, the silica substrate and the GaN substrate have a small etching rate. Therefore, a temperature of these substrates tends to increase in the etching process. SiC has a linear expansion coefficient of 4.2×10⁻⁶/degrees C. Ni has a linear expansion coefficient of 12.8×10−6/degrees C. On the other hand, sapphire has a linear expansion coefficient of 7.5×10⁻⁶/degrees C. Si has a linear expansion coefficient of 3.5×10⁻⁶/degrees C. GaN has a linear expansion coefficient of 15.59×10⁻⁶/degrees C. A problem is generated because of the thermal expansion coefficient differential between the substrate and the metal substrate, when a substrate other than the SiC substrate is used. It is therefore effective to provide the second open pattern 32.

It is preferable that the layer (the epitaxial layer 12 or the GaN-based semiconductor layer 15) provided on the substrate is a GaN-based semiconductor layer or a SiC layer. For example, it is possible to adopt combinations of a SiC substrate and a SiC layer, a SiC substrate and a SiC layer, a SiC substrate and a GaN-based semiconductor layer, a sapphire substrate and a GaN-based semiconductor layer, and a GaN substrate and a GaN-based semiconductor layer. The GaN-based semiconductor layer 15 is a layer including GaN, and may be composed of AlGaN in which AlN (aluminum nitride) and GaN are mixed or of InGaN in which InN (indium nitride) and GaN are mixed.

In a case where the temperature of the substrate is more than 100 degrees C. in the dry etching treatment shown in FIG. 4C, the thermal stress is enlarged in particular. It is therefore effective to provide the second open pattern 32.

It is preferable that the metal mask is composed of a material having a large etching selectivity with respect to the substrate 10. The-metal mask may be composed of a metal other than Ni. The etching selectivity may be more than 50, when the SiC substrate is subjected to an etching treatment with use of the metal mask 20 composed of Ni. For example, the etching selectivity is large when the metal mask 20 is composed of Cu. Cu has a linear expansion coefficient of 15.59×10⁻⁶/degrees C., and has a problem caused by the thermal expansion coefficient differential between the substrate and the metal mask as is the case of Ni. It is therefore effective to provide the second open pattern 32.

While the above description constitutes the preferred embodiments of the present invention, it will be appreciated that the invention is susceptible of modification, variation and change without departing from the proper scope and fair meaning of the accompanying claims.

The present invention is based on Japanese Patent Application No. 2006-279351 filed on Oct. 13, 2006, the entire disclosure of which is hereby incorporated by reference.

What is claimed is:

1. A manufacturing method of a semiconductor device comprising:
forming a metal mask on a substrate or on a layer provided on the substrate,
the metal mask having a first open pattern and a second open pattern,
the first open pattern being opened at a given area of the metal pattern,
the second open pattern being opened at an area dividing the metal mask; and
removing at least one of the substrate and the layer provided on the substrate selectively through a dry etching treatment with use of the metal mask.

2. The method as claimed in claim 1, wherein the first open pattern is a pattern for forming a through hole in the substrate.

3. The method as claimed in claim 1, wherein the second open pattern is a pattern for forming a recess crossing an area that is to be a chip.

4. The method as claimed in claim 1, wherein the second open pattern is formed in an area that is to be a scribe line.

5. The method as claimed in claim 1 further comprising an etching stopper layer in the layer provided on the substrate in an area where the second open pattern is to be formed.

6. The method as claimed in claim 1, wherein at least one of the substrate and the layer provided on the substrate is selectively removed through the dry etching treatment, with the substrate being adhered to a support substrate.

7. The method as claimed in claim 1, wherein the substrate is composed of Si, SiC, sapphire, silica or GaN.

8. The method as claimed in claim 1, wherein the layer provided on the substrate is a GaN-based semiconductor layer or a SiC layer.

9. The method as claimed in claim 1, wherein the metal mask includes Ni or Cr.

10. The method as claimed in claim 1, wherein at least one of the substrate and the layer provided on the substrate is selectively removed through the dry etching treatment in a condition where a temperature of the substrate is more than 100 degrees C.

11. The method as claimed in claim 1, wherein at least one of the substrate and the layer provided on the substrate is selectively removed with use of an ICP etching device or an ECR etching device.
